(19) United States
(12) Patent Application Publication
(10) Pub. No.: US 2025/0209174 A1
(43) Pub. Date: Jun. 26, 2025

(54) Industrial Device and Method for Operating a Industrial Device

(71) Applicant: Siemens Aktiengesellschaft, München (DE)

(72) Inventors: Rainer Falk, Erding (DE); Fabrizio De Santis, München (DE); Andreas Furch, Freising (DE); Malek Safieh, München, Bayern (DE); Daniel Schneider, München (DE); Florian Wilde, München (DE); Thomas Zeschg, München (DE)

(73) Assignee: Siemens Aktiengesellschaft, München (DE)

(21) Appl. No.: 18/850,328

(22) PCT Filed: Mar. 20, 2023
(86) PCT No.: PCT/EP2023/057001

§ 371 Date: Sep. 24, 2024

(30) Foreign Application Priority Data
Mar. 24, 2022 (EP) 22164153.3

(51) Int. Cl. G06F 21/57; G06F 21/64; G06F 21/86

(52) U.S. Cl. CPC G06F 21/57; G06F 21/64; G06F 21/86

(57) ABSTRACT

Various embodiments of the teachings herein include an industrial device. An example includes: a number of integrity measuring units for providing integrity measurement values; an attestation unit to provide an integrity attestation protected by a first cryptographic protection indicating an integrity of the device or of a part of the device, wherein the integrity attestation has a number of provided integrity measurement values; and a confirmation unit connected to the attestation unit via a physically protected transmission path, the confirmation unit comprising: a checking unit to provide checking information by checking a state of the confirmation unit and/or of the industrial device, and an issuing unit to issue a confirmation attestation protected by a second cryptographic protection depending on the provided checking information. The confirmation attestation comprises the number of integrity measurement values of the integrity attestation and information derivable from the first cryptographic protection of the integrity attestation.

### CROSS-REFERENCE TO RELATED APPLICATIONS

This application is a U.S. National Stage Application of International Application No. PCT/EP2023/057001 filed Mar. 20, 2023, which designates the United States of America, and claims priority to EP application Ser. No. 22164,153.3 filed Mar. 24, 2022, the contents of which are hereby incorporated by reference in their entirety.

### TECHNICAL FIELD

The present disclosure relates to industrial devices. Various embodiments of the teachings herein include systems and/or methods for operating a industrial device.

### BACKGROUND

A computer-aided industrial device comprises an attestation unit for providing an attestation, which is protected by a first cryptographic protection, for indicating an integrity of the industrial device. An attestation or integrity attestation is a cryptographically protected data structure for confirming integrity information for example of an execution environment of the industrial device vis-à-vis a communication partner. The latter can take this information into account, for example in the course of provisioning/credential management or in the course of a critical application functionality, such as online banking, for example.

In practice, the attestation is often formed by a hardware element, in particular by a tamperproof computing apparatus, for example by a TPM chip (TPM; trusted platform module) or by a security element integrated in a processor or in an ASIC. Such signatures formed in a hardware-based manner are conventionally not updatable. In this regard, an RSA signature, a DSA signature or an EC-DSA signature is usually used. The key lengths supported here are often relatively short, for example 2048 bits in the case of RSA.

In general, in an industrial application context there is often the requirement of securely using devices over a long period of use, for example 10 to 30 years. During such a long period, the cryptographic algorithms used may also be inherently weakened by new attacks, for example by quantum computers, or hardware-realized implementations may have weak points.

If, as explained above, an attestation is formed by a hardware element, in practice it is often not updatable, or only updatable at very great expense. On the other hand, precisely for the attestation of integrity information, a hardware element has the advantage that it can keep trustworthy the integrity information for characterizing a runtime environment, for example because information once acquired can only be updated, but cannot be arbitrarily overwritten or reset. In particular, it may be possible that the signature device of the hardware element or the key used by this signature device cannot be updated or at least cannot be updated by a manufacturer or an operator of the industrial device. Therefore, it is not possible to reliably ensure that the integrity attestation function offers the long-term suitability and updatability required for an industrial device.

It is known from the document EP 3 695 377 B1 that the contents of an attestation are preprocessed by a confirmation device and processed attestation information is provided by the confirmation device.

### SUMMARY

Teachings of the present disclosure may be used to improve the operation of a computer-aided industrial device, in particular with regard to an updatable attestation functionality having long-term suitability. For example, some embodiments of the teachings herein include a computer-aided industrial device (1), comprising: a number of integrity measuring units (2) for respectively providing an integrity measurement value (IM), an attestation unit (3) for providing an integrity attestation (IA), which is protected by a first cryptographic protection (DS1), for indicating an integrity of the industrial device (1) or of a part of the industrial device (1), wherein the integrity attestation (IA) has at least a number of provided integrity measurement values (IM), and a confirmation unit (5) connected to the attestation unit (3) via a physically protected transmission path (4) and comprising: a checking unit (6) for providing checking information (PI) by means of checking at least one state of the confirmation unit (5) and/or of the industrial device (1), and an issuing unit (7) for issuing a confirmation attestation (BA), which is protected by a second cryptographic protection (DS2), depending on the provided checking information (PI), wherein the confirmation attestation (BA) comprises at least the number of integrity measurement values (IM) of the integrity attestation (IA) and information derivable from the first cryptographic protection (DS1) of the integrity attestation (IA).

In some embodiments, the first cryptographic protection (DS1) is embodied as a first digital signature (DS1), and/or the second cryptographic protection (DS2) is embodied as a second digital signature (DS2).

In some embodiments, the attestation unit (3) is configured to provide the cryptographically protected integrity attestation (IA) in such a way that the latter (IA) comprises the number of integrity measurement values (IM) and the first digital signature (DS1), and/or the confirmation unit (5) is configured to provide the cryptographically protected confirmation attestation (BA) in such a way that the latter (BA) comprises at least the number of integrity measurement values (IM) and the first digital signature (DS1) of the integrity attestation (IA) and also the second digital signature (DS2) of the confirmation attestation (BA).

In some embodiments, the confirmation unit (5) is configured to provide the cryptographically protected confirmation attestation (BA) in such a way that the latter (BA) comprises the number of integrity measurement values (IM) and the first digital signature (DS1) of the integrity attestation (IA), the second digital signature (DS2) of the confirmation attestation (BA) and the checking information (PI) and/or information which is derivable from the checking information (PI) and which is indicative of the formation of the confirmation attestation (BA) in the confirmation unit (5).

In some embodiments, the attestation unit (3) has a first storage unit (9), secured against external access, for storing a first cryptographic credential (K1) assigned to the first cryptographic protection (DS1), and/or the confirmation unit (5) has an updatable second storage unit (14) for storing a second cryptographic credential (K2) assigned to the second cryptographic protection (DS2).

In some embodiments, the first cryptographic protection (DS1) is embodied as a first digital signature (DS1) and the first cryptographic credential (K1) is embodied as a private key (K1) assigned to the first digital signature (DS1), and/or the second cryptographic protection (DS2) is embodied as a second digital signature (DS2) and the second cryptographic credential (K2) is embodied as a private key (K2) assigned to the second digital signature (DS2).

In some embodiments, the checking unit (6) is connected to a number of physical sensors (13) installed in the industrial device (1) or on the industrial device (1) and serving for providing sensor signals (SS) indicative of the state of the confirmation unit (5) and/or of the industrial device (1).

In some embodiments, the checking unit (6) for providing the checking information (PI) is configured to check a firmware status of the confirmation unit (5), to check an output signal of a housing circuit breaker of the industrial device (1), to check an output signal of a tamper protection sensor of the industrial device (1), to check an output signal of a voltage sensor for monitoring a voltage supply of the industrial device (1) and/or to check whether a present temperature yielded by a temperature sensor installed in or on the industrial device (1) lies within a predetermined temperature range.

In some embodiments, the attestation unit (3) is embodied as a tamperproof computing apparatus, in particular as a trusted platform module (TPM).

In some embodiments, the industrial device (1) has a single housing, in which the attestation unit (3), the confirmation unit (5) and the physically protected transmission path (4) connecting the attestation unit (3) and the confirmation unit (5) are arranged.

In some embodiments, the industrial device (1) has a housing with the attestation unit (3) arranged therein, the confirmation unit (5) being embodied as an attachment module for attachment to a bus of the industrial device (1).

In some embodiments, the industrial device (1) has a slide-in housing, the confirmation unit (5) or the confirmation unit (5) and the attestation unit (3) being embodied as a respective slide-in module for insertion into the slide-in housing.

As another example, some embodiments include a system, comprising a computer-aided industrial device (1) as described herein, and a backend system (24) coupled to the industrial device (1) via a network (23) and configured to check the confirmation attestation (BA) issued by the industrial device (1) in order to ascertain the integrity of the industrial device (1).

As another example, some embodiments include a computer-implemented method for operating a computer-aided industrial device (1), comprising: providing (S1) an integrity measurement value (IM) by means of an integrity measuring unit (2) of the industrial device (1), providing (S2) an integrity attestation (IA), which is protected by a first cryptographic protection (DS1), for indicating an integrity of the industrial device (1) or of a part of the industrial device (1), wherein the integrity attestation (IA) has at least a number of provided integrity measurement values (IM), and providing (S3) checking information (PI) by means of checking at least one state of the confirmation unit (5) and/or of the industrial device (1), and issuing a confirmation attestation (BA), which is protected by a second cryptographic protection (DS2), depending on the provided checking information (PI), wherein the confirmation attestation (BA) comprises at least the number of integrity measurement values (IM) of the integrity attestation (IA) and information derivable from the first cryptographic protection (DS1) of the integrity attestation (IA).

As another example, some embodiments include a computer program product which causes one or more of the methods described herein to be carried out on a program-controlled device.

### BRIEF DESCRIPTION OF THE DRAWINGS

Further advantageous configurations and aspects of the teachings herein are described in relation to the example embodiments described below. The teachings are explained in greater detail hereinafter on the basis of preferred embodiments with reference to the accompanying figures. In the drawings:

FIG. 1 shows a schematic block diagram of an example computer-aided industrial device incorporating teachings of the present disclosure;

FIG. 2 shows a schematic diagram of an example of an integrity attestation incorporating teachings of the present disclosure;

FIG. 3 shows a schematic diagram of an example a confirmation attestation incorporating teachings of the present disclosure;

FIG. 4 shows a schematic block diagram of an example computer-aided industrial device incorporating teachings of the present disclosure;

FIG. 5 shows a schematic block diagram of an example system incorporating teachings of the present disclosure comprising a computer-aided industrial device; and

FIG. 6 shows a flowchart of an example method incorporating teachings of the present disclosure for operating a computer-aided industrial device.

### DETAILED DESCRIPTION

Some embodiments of the teachings herein include a computer-aided industrial device which has a number of integrity measuring units for respectively providing an integrity measurement value, an attestation unit for providing an integrity attestation, which is protected by a first cryptographic protection, for indicating an integrity of the industrial device or of a part of the industrial device, wherein the integrity attestation has at least a number of provided integrity measurement values, and a confirmation unit connected to the attestation unit via a physically protected transmission path. The confirmation unit comprises a checking unit and an issuing unit. The checking unit is configured for providing checking information by means of checking at least one state of the confirmation unit and/or of the industrial device. The issuing unit is configured for issuing a confirmation attestation, which is protected by a second cryptographic protection, depending on the provided checking information, wherein the confirmation attestation comprises at least the number of integrity measurement values of the integrity attestation and information derivable from the first cryptographic protection of the integrity attestation.

The attestation unit is in particular a tamperproof computing apparatus, for example a trusted platform module (TPM), and may in particular also be referred to as a secure element, a hardware element or a hardware security component. The attestation unit is in particular not updatable, or only updatable at great expense. The confirmation unit is coupled to the attestation unit via the physically protected transmission path. The confirmation unit is realized in particular as a separate hardware module in the industrial device.

The present computer-aided industrial device is able, by virtue of the confirmation unit, to form a cryptographically protected confirmation attestation of a cryptographically protected integrity attestation, formed by the attestation unit. In this case, the confirmation attestation formed comprises at least the integrity measurement values of the integrity attestation and information derivable from the first cryptographic protection of the integrity attestation. This makes it possible to provide an attestation having long-term suitability on the industrial device, wherein a hardware element as attestation unit at the present time and also in the future can only form a conventional, classical attestation not having PQ capability (PQ; post-quantum cryptography).

The industrial device may also be referred to as a device for industry. The industrial device is in particular a real physical device, for example an embedded device or an industrial IoT device. In some embodiments, the industrial device may also be a virtualized industrial device, for example a virtual machine, an app or a container on a generic computer platform.

In the present case, this accordingly makes it possible for conventional attestations, namely the integrity attestations, which are often standardized and fixedly implemented in hardware and hence not updatable, to be protected by an additional cryptographic protection, in the present case by the use of the confirmation unit. The additional protection by the confirmation unit is in particular updatable, such that the integrity attestations can be reliably evaluated, even if the cryptographic methods used in the process are already weakened. The additional protection here makes it possible to assess whether the additional protection effected is actually permissible for protecting a specific integrity attestation. An improper use of the additional protection is prevented in this case.

The cryptographically protected confirmation attestation can be communicated to a communication partner of the industrial device, for example a backend system. The communication partner fulfils in particular a device management/provisioning service for the management and provisioning of the industrial device. The communication partner can check the cryptographic validity and the contents permissibility both of the integrity attestation and additionally of the cryptographically protected confirmation attestation before provisioning, for example provision of a credential, a key, a certificate or a security token of the industrial device, is enabled or effected, or before a critical device management operation is effected, for example a firmware update, an update of configuration data and/or provision of sensitive production data.

In some embodiments, the information derivable from the first cryptographic protection of the integrity attestation corresponds to the first cryptographic protection. For the embodiments in which the first cryptographic protection corresponds to the first digital signature, the information is derivable from the first digital signature or corresponds thereto. The respective integrity measurement value relates in particular to a component of the industrial device, for example to the firmware, to the software, to the configuration or to one of the hardware components of the industrial device.

In some embodiments, the industrial device comprises a plurality of integrity measuring units, each of which ascertains an integrity measurement value and provides it to the attestation unit. The integrity measurements can in particular also involve cryptographic hash values of loaded firmware components or software components and of configuration data. Furthermore, results of integrated self-test functions (built-in self-tests) can be acquired as integrity measurements. Furthermore, hardware fingerprints of hardware components of the industrial device can also be acquired as integrity measurements.

In the present disclosure, cryptographic protection encompasses in particular integrity protection, authenticity and/or confidentiality.

In some embodiments, the first cryptographic protection is embodied as a first digital signature. In some embodiments, the second cryptographic protection is embodied as a second digital signature.

In some embodiments, the attestation unit is configured to provide the cryptographically protected integrity attestation in such a way that the latter comprises the number of integrity measurement values and the first digital signature. The integrity attestation can also comprise further information, for example identification information of the industrial device, identification information of the attestation unit and/or information pertaining to an up-to-date status, such as for example a time stamp or a counter value.

In some embodiments, the confirmation unit is configured to provide the cryptographically protected confirmation attestation in such a way that the latter comprises at least the number of integrity measurement values and the first digital signature of the integrity attestation and also the second digital signature of the confirmation attestation.

In some embodiments, the confirmation unit is configured to provide the cryptographically protected confirmation attestation in such a way that the latter comprises the number of integrity measurement values and the first digital signature of the integrity attestation, the second digital signature of the confirmation attestation and the checking information and/or information which is derivable from the checking information and which is indicative of the formation of the confirmation attestation in the confirmation unit.

The checking information itself and also the information derivable from the checking information are in particular suitable for indicating that the confirmation attestation has been formed in the confirmation unit. The checking information or the information derivable from the checking information is in particular part of confirmation attestation formation information or embodies the latter. The confirmation attestation formation information characterizes in particular the manner in which the confirmation attestation was formed.

In some embodiments, the confirmation attestation formation information is part of the confirmation attestation. Indirectly it thus also allows the manner in which the integrity confirmation was formed to be deduced. This additional information makes it possible for a receiver of the confirmation attestation to decide whether this manner of formation is deemed to be permissible in accordance with a predefinable guideline or policy. Depending on this, the integrity attestation confirmed by the confirmation attestation is or is not accepted by the receiver.

The confirmation attestation formation information can comprise in particular the following sub-information items for characterizing the manner of formation of the confirmation attestation:
device identifier of the industrial device, for example serial number and/or software version;
attestation of the own system integrity of the confirmation unit by means of a PQ signature (PQ; post-quantum cryptography), for example by means of a PQ-TPM, or by transmission via a PQ-secure transmission path;
present operating mode of the industrial device on which the confirmation attestation was formed, for example service, operation, start-up, firmware update, failure;
type of execution environment in which the confirmation attestation was formed, for example an SGX enclave, a trusted execution environment (TEE), a crypto-controller, a hardware security module (HSM);
present environment information of the execution environment in which the confirmation attestation was formed, for example time information or position information ascertained for example by a localization system or by means of a satellite-aided navigation system, such as GPS, GALILEO, BEIDOU, GLONASS;
checking of the provided integrity attestation, for example checking of the digital signature of the integrity attestation, or plausibilization the integrity contents assessment of information attested by the integrity attestation, and/or checking of the interface via which the integrity attestation was received.

In some embodiments, the confirmation attestation comprises the integrity attestation in an encrypted form. For this purpose, the present integrity attestation is cryptographically encrypted during the formation of the confirmation attestation by the confirmation unit.

In some embodiments, the attestation unit comprises a first storage unit, secured against external access, for storing a first cryptographic credential assigned to the first cryptographic protection.

In some embodiments, the confirmation unit comprises an updatable second storage unit for storing a second cryptographic credential assigned to the second cryptographic protection. In embodiments, the implementation, for example the firmware and/or the software, for forming the second cryptographic protection is also updatable.

In some embodiments, the first cryptographic protection is embodied as a first digital signature and the first cryptographic credential is embodied as a private key assigned to the first digital signature.

In some embodiments, the second cryptographic protection is embodied as a second digital signature and the second cryptographic credential is embodied as a private key assigned to the second digital signature.

In some embodiments, the checking unit is connected to a number of physical sensors installed in the industrial device or on the industrial device and serving for providing sensor signals indicative of the state of the confirmation unit and/or of the industrial device. The physical sensors are configured in particular for ascertaining temperature, air pressure, air humidity, vibrations, acceleration, and/or for recognizing physical manipulations.

In some embodiments, the checking unit for providing the checking information is configured to check a firmware status of the confirmation unit, to check an output signal of a housing circuit breaker of the industrial device, to check an output signal of a tamper protection sensor of the industrial device, to check an output signal of a voltage sensor for monitoring a voltage supply of the industrial device and/or to check whether a present temperature yielded by a temperature sensor installed in or on the industrial device lies within a predetermined temperature range.

In some embodiments, the confirmation unit comprises an integrity checking unit connected upstream of the issuing unit, in particular. The integrity checking unit is configured to locally check the validity of the integrity attestation provided by the attestation unit. In this case, the integrity checking unit checks in particular the digital signature of the integrity attestation. In some embodiments, the integrity checking unit can also evaluate the contents of the integrity measurement values that are part of the integrity attestation, and in particular can check them with regard to up-to-date status and/or plausibility.

In some embodiments, the attestation unit is embodied as a tamperproof computing apparatus. The tamperproof computing apparatus is in particular a trusted platform module (TPM).

In some embodiments, the industrial device has a single housing, in which the attestation unit, the confirmation unit and the physically protected transmission path connecting the attestation unit and the confirmation unit are arranged.

In some embodiments, the industrial device has a housing with the attestation unit arranged therein, the confirmation unit being embodied as an attachment module for attachment to a bus of the industrial device.

In some embodiments, the industrial device has a slide-in housing, the confirmation unit or the confirmation unit and the attestation unit being embodied as a respective slide-in module for insertion into the slide-in housing.

The respective unit, for example the attestation unit, the checking unit or the issuing unit, can be implemented in terms of hardware and/or else in terms of software. In the case of an implementation in terms of hardware, the respective unit can be embodied as an apparatus or as part of an apparatus, for example as a computer or as a microprocessor or as an integrated circuit. In the case of an implementation in terms of software, the respective unit can be embodied as a computer program product, as a function, as a routine, as part of a program code or as an executable object.

In some embodiments, a system comprises a computer-aided industrial device as described herein and a backend system coupled to the industrial device via a network. The backend system is configured to check the confirmation attestation issued by the industrial device in order to ascertain the integrity of the industrial device.

The confirmation attestation issued by the industrial device is provided to the system for checking purposes via the network. Depending on the checking of the confirmation attestation and the integrity attestation confirmed thereby, a security-relevant action can be enabled or initiated by the system. This can be in particular providing or confirming a cryptographic key to the industrial device or to the confirmation unit. In this case, the confirmation attestation can be protected in particular by a PQ signature or by transmission via a PQ-secure transmission path, for example using a key encapsulation method (KEM method, KEM: key encapsulation mechanism) such as e.g. KEMTLS.

The backend system is for example a cloud system, an edge cloud system or a production monitoring system. In this case, the backend system can also be a system situated locally in the factory with the industrial device.

In some embodiments, a computer-implemented method for operating a computer-aided industrial device comprises: providing a number of integrity measurement values by means of at least one integrity measuring unit of the industrial device, providing an integrity attestation, which is protected by a first cryptographic protection, for indicating an integrity of the industrial device or of a part of the industrial device, wherein the integrity attestation has at least a number of provided integrity measurement values, and providing checking information by means of checking at least one state of the confirmation unit and/or of the industrial device, and issuing a confirmation attestation, which is protected by a second cryptographic protection, depending on the provided checking information, wherein the confirmation attestation comprises at least the number of integrity measurement values of the integrity attestation and information derivable from the first cryptographic protection of the integrity attestation.

The embodiments and features described for the proposed industrial devices apply, mutatis mutandis, to the proposed methods.

In some embodiments, a computer program product causes one or more of the methods described herein to be carried out on a program-controlled device. A computer program product such as e.g. a computer program means can be provided or supplied for example as a storage medium, such as e.g. memory card, USB stick, CD-ROM, DVD, or else in the form of a downloadable file from a server in a network. This can be done for example in a wireless communication network by the transmission of a corresponding file with the computer program product or the computer program means.

Further possible implementations of the teachings herein also encompass not explicitly mentioned combinations of features or embodiments described above or below with regard to the exemplary embodiments. In this case, the person skilled in the art will also add individual aspects as improvements or supplementations to the respective basic forms. In the figures, identical or functionally identical elements have been provided with the same reference signs, unless indicated otherwise.

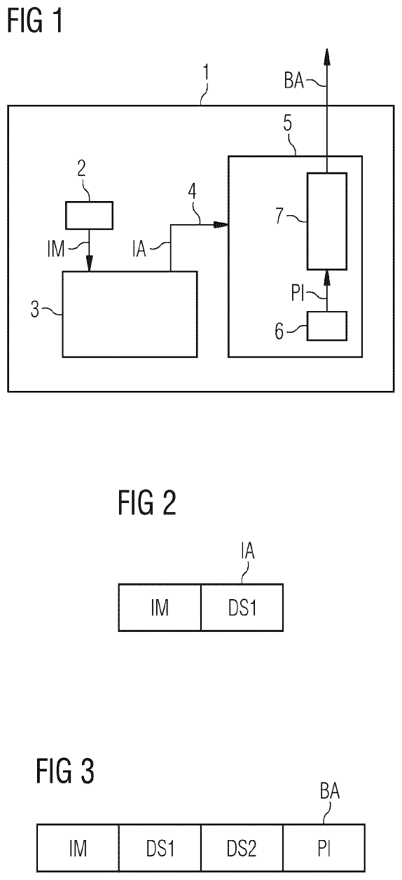

FIG. 1 shows a schematic block diagram of an example computer-aided industrial device 1 incorporating teachings of the present disclosure. The industrial device 1 is computer-aided and accordingly comprises computing capacities and storage capacities, in particular a computer or microprocessor and at least one memory, such as for example a RAM memory and/or a ROM memory.

The exemplary embodiment according to FIG. 1 will be explained with reference to FIGS. 2 and 3. The industrial device 1 in FIG. 1 comprises an integrity measuring unit 2, an attestation unit 3, and a confirmation unit 5 connected to the attestation unit 3 via a physically protected transmission path 4. The confirmation unit 5 comprises a checking unit 6 and an issuing unit 7. The attestation unit 3 is embodied in particular as a tamperproof computing apparatus. The tamperproof computing apparatus is for example a trusted platform module (TPM). The integrity measuring unit 2 is for example a root of trust for measurement unit (RTM).

The integrity measuring unit 2 is configured to provide an integrity measurement value IM. The integrity measurement value IM relates in particular to a component of the industrial device 1, for example to the firmware, to the software, to the configuration or to a hardware component of the industrial device 1.

The attestation unit 3 receives the integrity measurement value IM and, on the output side, provides an integrity attestation IA, which is protected by a first cryptographic protection DS1 (cf. FIG. 2), for indicating an integrity of the industrial device 1 or of a part of the industrial device 1. The first cryptographic protection DS1 is embodied in particular as a first digital signature. The integrity attestation IA comprises for example-as illustrated in FIG. 2-the provided integrity measurement value IM and the first digital signature DS1. It is also possible for the attestation unit 3 to confirm, in the integrity attestation IA formed by it, an integrity measurement value that the attestation unit forms depending on the integrity measurement value IM received from the integrity measuring unit 2. The attestation unit 3 can ascertain for example a cryptographic hash value depending on the integrity measurement value IM received from the integrity measuring unit 2 and can confirm this value as integrity measurement value in the integrity attestation IA.

The checking unit 6 is configured to provide checking information PI by means of checking at least one state of the confirmation unit 5 and/or of the industrial device 1.

The issuing unit 7 is configured to issue and provide on the output side a confirmation attestation BA, which is protected by a second cryptographic protection DS2, depending on the provided checking information PI. In the exemplary embodiment according to FIG. 3, the confirmation attestation BA comprises the provided integrity measurement value IM and the first digital signature DS1 of the integrity attestation IA and also the second digital signature DS2 of the confirmation attestation BA and the checking information PI or information which is derivable from the checking information PI and which is indicative of the formation of the confirmation attestation BA in the confirmation unit 5. In an alternative illustration in respect of FIG. 3, the second digital signature DS2 could also be illustrated on the far right since it preferably also protects the checking information PI.

The second digital signature DS2 can protect the integrity of the integrity measurement value IM, of the first digital signature DS1 and of the checking information PI. It should be emphasized that both the checking information PI itself and the information derivable from the checking information PI are suitable for indicating that the confirmation attestation BA has been formed in the confirmation unit 5 or that the confirmation attestation BA has been formed in a non-manipulated confirmation unit 5. Furthermore, the checking information PI itself and also the information derivable from the checking information PI can be suitable for indicating that the acquisition of the integrity measurement value IM by the integrity measuring unit 2, the transmission of the integrity measurement value IM from the integrity measuring unit 2 to the attestation unit 3, the formation of the integrity attestation IA by the attestation unit 3 and/or the transmission of the integrity attestation IA from the attestation unit 3 to the confirmation unit 5 via the physically protected transmission path 4 have been effected without manipulation.

The industrial device 1 comprises for example a single housing, in which the attestation unit 3, the confirmation unit 5 and the physically protected transmission path 4 connecting the attestation unit 3 and the confirmation unit 5 are arranged. In some embodiments, the industrial device 1 comprises a housing with the attestation unit 3 arranged therein, the confirmation unit 5 being embodied as an attachment module for attachment to a bus (not shown) of the industrial device 1. In some embodiments, the industrial device 1 comprises a slide-in housing, the confirmation unit 5 or the confirmation unit 5 and the attestation unit 3 being embodied as a respective slide-in module for insertion into the slide-in housing.

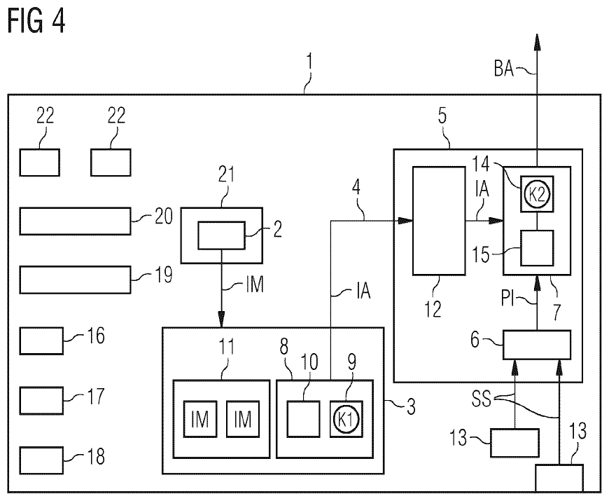

FIG. 4 shows a schematic block diagram of an example computer-aided industrial device 1 incorporating teachings of the present disclosure. The embodiment according to FIG. 4 comprises all the features of the embodiment according to FIGS. 1 to 3 and moreover an integrity unit 8 arranged in the attestation unit 3 and having a storage unit 9 and a signature unit 10, and also a register 11. The confirmation unit 5 in FIG. 4 comprises the checking unit 6, the issuing unit 7 having a storage unit 14 and a signing unit 15, and also an integrity checking unit 12. The checking unit 6 in FIG. 4 is coupled to a number of sensors 13. Without restricting generality, FIG. 4 shows two sensors 13.

Furthermore, the industrial device 1 in FIG. 4 has a CPU 16, a RAM memory 17, an SSD memory 18, a bootloader 19, an operating system 20, an execution environment 21 and a number of applications 22. In the exemplary embodiment in FIG. 4, the integrity measuring unit 2 is arranged in the execution environment 21. The execution environment 21 is for example a real-time environment. Furthermore, further integrity measuring units 2 can be arranged for example in the bootloader 19 and in the operating system 20. The integrity measurement values IM provided by the integrity measuring units 2 are stored in the register 11 of the attestation unit 3.

The storage unit 9 of the attestation unit 3 is in particular a storage unit secured against external access and stores a first cryptographic credential K1 assigned to the first cryptographic protection DS1. The cryptographic credential K1 is for example a private key of the attestation unit 3.

In contrast thereto, the storage unit 14 of the confirmation unit 5 is designed as an updatable storage unit and stores a second cryptographic credential K2 assigned to the second cryptographic protection DS2. The second cryptographic credential K2 is for example a private key of the confirmation unit 5.

The sensors 13 already mentioned above are installed in the housing of the industrial device 1 or on the housing of the industrial device 1 and are suitable for providing sensor signals SS which are indicative of the state of the confirmation unit 5 and/or of the state of the industrial device 1.

In this case, the checking unit 6 for providing the checking information PI is configured in particular to check a firmware status of the confirmation unit 5, to check an output signal of a housing circuit breaker of the industrial device 1, to check an output signal of a tamper protection sensor of the industrial device 1, to check an output signal of a voltage sensor for monitoring a voltage supply of the industrial device 1 and/or to check whether a present temperature yielded by a temperature sensor installed in or on the industrial device 1 lies within a predetermined temperature range.

As mentioned above, the confirmation unit 5 comprises an integrity checking unit 12, which is connected upstream of the issuing unit 7, in particular. The integrity checking unit 12 is configured to locally check the validity of the integrity attestation IA provided by the attestation unit 3. In this case, the integrity checking unit 12 checks in particular the digital signature DS1 of the integrity attestation IA. Additionally or alternatively, the integrity checking unit 12 can also evaluate the contents of the integrity measurement values IM that are part of the integrity attestation IA, and in particular can check them with regard to up-to-date status and/or plausibility.

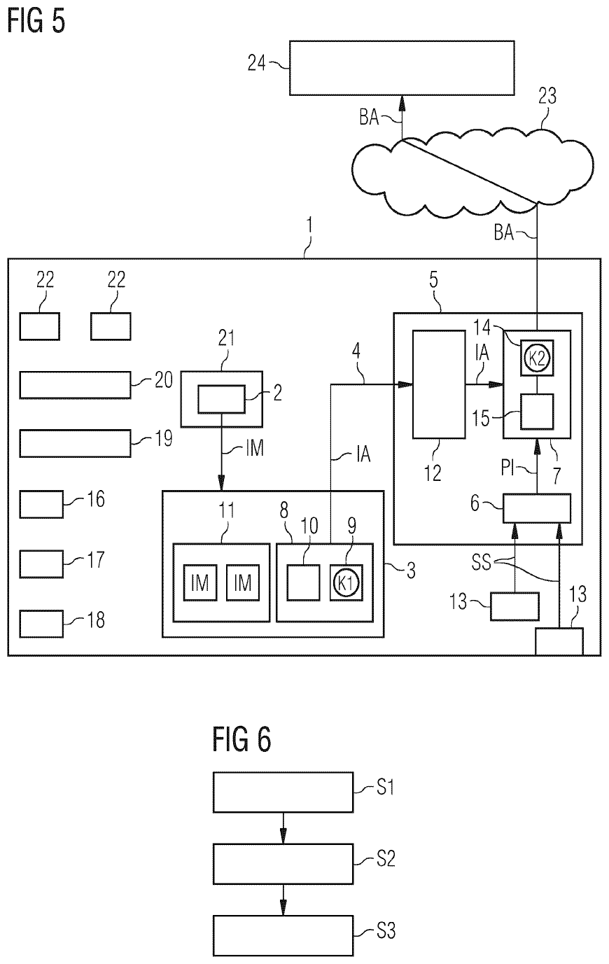

FIG. 5 illustrates a schematic block diagram of an example system comprising a computer-aided industrial device 1, a network 23 and a backend system 24 incorporating teachings of the present disclosure. The industrial device 1 according to FIG. 5 is based on the embodiment of the industrial device 1 according to FIG. 4. The network 23 couples the industrial device 1 and the backend system 24. The network 23 can comprise IP, WLAN and/or other systems and also subnetworks. The industrial device 1-as explained in detail above in regard to FIG. 4-provides a confirmation attestation BA on the output side. The confirmation attestation BA is transmitted to the backend system 24 via the network 23. The backend system 24 is configured to check the confirmation attestation BA issued by the industrial device 1 in order to ascertain the integrity of the industrial device 1.

The backend system 24 is for example a cloud system, an edge cloud system or a production monitoring system. As shown by the example of the production monitoring system, the backend system 24 can also be a system situated locally in a factory and comprising the industrial device 1.

FIG. 6 illustrates a flowchart of an example method incorporating teachings of the present disclosure for operating a computer-aided industrial device 1. The method according to FIG. 6 comprises elements S1, S2, and S3:
S1 includes providing at least one integrity measurement value IM by means of an integrity measuring unit 2 of the industrial device 1.
S2 includes providing an integrity attestation IA, which is protected by a first cryptographic protection DS1, for indicating an integrity of the industrial device 1 or of a part of the industrial device 1. In this case, the integrity attestation IA comprises at least the at least one provided integrity measurement value IM.
S3 includes providing checking information PI by means of checking at least one state of the confirmation unit 5 and/or of the industrial device 1, and on the basis thereof providing a confirmation attestation BA, which is protected by a second cryptographic protection DS2, depending on the provided checking information PI. In this case, the confirmation attestation BA comprises at least the number of integrity measurement values IM of the integrity attestation IA and information derivable from the first cryptographic protection DS1 of the integrity attestation IA.

What is claimed is:

1. A computer-aided industrial device comprising:
a number of integrity measuring units for respectively providing an integrity measurement value;
an attestation unit to provide an integrity attestation protected by a first cryptographic protection for indicating an integrity of the device or of a part of the device, wherein the integrity attestation has a number of provided integrity measurement values; and
a confirmation unit connected to the attestation unit via a physically protected transmission path, the confirmation unit comprising:
a checking unit to provide checking information by checking a state of the confirmation unit and/or of the industrial device, and
an issuing unit to issue a confirmation attestation protected by a second cryptographic protection depending on the provided checking information;
wherein the confirmation attestation comprises the number of integrity measurement values of the integrity attestation and information derivable from the first cryptographic protection of the integrity attestation.

2. The industrial device as claimed in claim 1, wherein:
that the first cryptographic protection comprises a first digital signature; and/or
the second cryptographic protection comprises a second digital signature.

3. The industrial device as claimed in claim 2, wherein:
the attestation unit provides the cryptographically protected integrity attestation including the number of integrity measurement values and the first digital signature; and/or
the confirmation unit provides the cryptographically protected confirmation attestation including at least the number of integrity measurement values and the first digital signature of the integrity attestation and the second digital signature of the confirmation attestation.

4. The industrial device as claimed in claim 3, wherein the confirmation unit provides the cryptographically protected confirmation attestation including the number of integrity measurement values and the first digital signature of the integrity attestation, the second digital signature of the confirmation attestation, and the checking information and/or information derivable from the checking information indicative of the formation of the confirmation attestation in the confirmation unit.

5. The industrial device as claimed in claim 1, wherein:
the attestation unit includes a first storage unit secured against external access for storing a first cryptographic credential assigned to the first cryptographic protection; and/or
the confirmation unit includes an updatable second storage unit for storing a second cryptographic credential assigned to the second cryptographic protection.

6. The industrial device as claimed in claim 5,
wherein:
the first cryptographic protection comprises a first digital signature and the first cryptographic credential comprises a private key assigned to the first digital signature; and/or
the second cryptographic protection comprises a second digital signature and the second cryptographic credential comprises a private key assigned to the second digital signature.

7. The industrial device as claimed in a claim 1, wherein the checking unit is connected to a number of physical sensors of the industrial device providing sensor signals indicative of the state of the confirmation unit and/or of the industrial device.

8. The industrial device as claimed in claim 1, wherein the checking unit is configured to:
check a firmware status of the confirmation unit;
check an output signal of a housing circuit breaker of the industrial device;
check an output signal of a tamper protection sensor of the industrial device;
check an output signal of a voltage sensor for monitoring a voltage supply of the industrial device; and/or
check whether a present temperature yielded by a temperature sensor the industrial device lies within a predetermined temperature range.

9. The industrial device as claimed in claim 1, wherein the attestation unit comprises a tamperproof computing apparatus.

10. The industrial device as claimed in claim 1, further comprising a single housing, in which the attestation unit, the confirmation unit, and the physically protected transmission path connecting the attestation unit and the confirmation unit are arranged.

11. The industrial device as claimed in claim 1, further comprising a housing with the attestation unit arranged therein;
Wherein the confirmation unit comprises an attachment module for attachment to a bus of the industrial device.

12. The industrial device as claimed in claim 1, further comprising a slide-in housing,
wherein at one of the confirmation unit or the confirmation unit and the attestation unit comprises a slide-in module for insertion into the slide-in housing.

13. A system comprising:
a backend system;
a computer-aided industrial device; and
a network connecting the backend system to the industrial device;
wherein the industrial device includes a number of integrity measuring units for respectively providing an integrity measurement value;
wherein the industrial device includes an attestation unit to provide an integrity attestation protected by first cryptographic protection for indicating an integrity of the device or of a part of the device, wherein the integrity attestation hasa number of provided integrity measurement values; and
wherein the industrial device includes confirmation unit connected to the attestation unit via a physically protected transmission path, the confirmation unit comprising: a checking unit to provide checking information by check a state of the confirmation unit and/or of the industrial device, and an issuing unit to issue a confirmation attestation protected by a second cryptographic protection depending on the provided checking information;
wherein the confirmation attestation comprises the number of integrity measurement values of the integrity attestation and information derivable from the first cryptographic protection of the integrity attestation; and
wherein the backend system is configured to check the confirmation attestation issued by the industrial device in order to ascertain the integrity of the industrial device.

14. A method for operating a computer-aided industrial device, the method comprising:
providing an integrity measurement value using an integrity measuring unit of the industrial device;
providing an integrity attestation protected by a first cryptographic protection to indicate an integrity of the industrial device or of a part of the industrial device, wherein the integrity attestation has a number of provided integrity measurement values;
providing checking information by checking at least one state of the confirmation unit and/or of the industrial device; and
issuing a confirmation attestation protected by a second cryptographic protection depending on the provided checking information;
wherein the confirmation attestation comprises at least the number of integrity measurement values of the integrity attestation and information derivable from the first cryptographic protection of the integrity attestation.

15. (canceled)
